(19) United States
(12) Patent Application Publication
(10) Pub. No.: US 2026/0351586 A1
(43) Pub. Date: Nov. 5, 2026

(54) SOLID-STATE MICROWAVE ROUTE TO CATION-DISORDERED ROCKSALT OXIDE AND OXYFLUORIDE CATHODES

(71) Applicant: THE REGENTS OF THE UNIVERSITY OF CALIFORNIA

(72) Inventors: Raphaële CLÉMENT, Santa Barbara, CA (US); Vincent WU, West Windsor, NJ (US)

(73) Assignee: THE REGENTS OF THE UNIVERSITY OF CALIFORNIA, OAKLAND, CA (US)

(21) Appl. No.: 19/123,669

(22) PCT Filed: Oct. 27, 2023
(86) PCT No.: PCT/US2023/078060

§ 371 Date: Apr. 23, 2025

Related U.S. Application Data
(60) Provisional application No. 63/420,230, filed on Oct. 28, 2022.

(51) Int. Cl. H01M 4/505; C01G 45/22; H01M 10/0525

(52) U.S. Cl. CPC H01M 4/505; C01G 45/22; H01M 10/0525; C01P 2002/72; C01P 2002/77; C01P 2002/86; C01P 2004/03; C01P 2004/61; C01P 2006/40

(57) ABSTRACT

Ionic solids, e.g., Disordered Rocksalt Oxide/Oxyfluoride (DRX) compositions, useful as Li-ion cathodes are synthesized via a microwave method that is two orders of magnitude faster than conventional solid-state and mechanochemical synthesis methods. The microwave synthesis can be conducted in ambient air, resulting in greatly reduced synthesis time, energy consumption, and cost. In one illustrative embodiment of the method, precursor powders are mixed and pressed into a pellet. The pellet is then placed into a ceramic crucible surrounded by activated carbon. The crucible is then placed into a 1200W microwave and heated for 5-20 minutes. Immediately after the microwave radiation has stopped, the pellet is rapidly removed from the crucible and quenched in water. The pellet is then dried and ground into a powder, which is the final DRX product.

### CROSS-REFERENCE TO RELATED APPLICATIONS

This application claims benefit of U.S. 63/420,230, as filed Oct. 28, 2022, the entire contents of which are incorporated herein by reference.

### FIELD OF THE INVENTION

The present disclosure relates to compositions of matter useful as electrodes and methods of making the same.

### BACKGROUND OF THE INVENTION

The increasing demand for energy dense, portable power has motivated the development of Li-ion batteries, with possible extension to sodium-ion Na-ion batteries. The cathode component is typically the most expensive and limiting in terms of charge storage capacity. The major fraction of transition metals used in current Li-ion cathodes consist of Co and/or Ni, whose toxicity (Co), complex supply chain, and price volatility are driving the development of more sustainable (e.g., Mn-based) cathode chemistries.

Cation-disordered rocksalt oxides/oxyfluorides (DRX) are promising options for high energy density M n-based and Co/Ni-free Li-ion (and possibly Na-ion) cathodes due to their high energy densities and compositional flexibility. DRX materials are currently synthesized via two routes¹⁻⁵: (1) solid-state synthesis, where precursors are heated at high temperatures (>800 °C) under an Ar flow for an extended time period (typically 12 hours); and (II) mechanochemical synthesis, where precursors are ball-milled for a minimum duration (>40 hours) in a sealed, inert environment.

These methods require an inert atmosphere to reduce impurity formation and are energy intensive. Furthermore, scaling up of the mechanochemical synthesis method for industrial scale manufacturing is not straightforward. What is needed are improved methods of synthesizing rocksalt structures.

### SUMMARY OF THE INVENTION

The present disclosure provides a method for the rapid synthesis of an ionic compound useful as a Li-ion (or Na-ion) battery electrode. The method comprises mixing precursors together to form a mixture; exposing the mixture to microwave radiation with a power of 100-1500 watts for a duration of less than 1 hour (e.g., 5-20 minutes) so as to produce an ionic compound with a rocksalt-type crystalline structure and a disordered arrangement of cations; stopping the microwave radiation and quenching the microwaved powder (within 15 seconds from the time the microwave heating is stopped) to retain the structure and disordered cation arrangement at room temperature. A disordered rocksalt-type structure can be determined by powder X-ray diffraction (XRD), where peaks can be indexed to the cubic rocksalt space group Fm-3m (space group #225). Cation short-range order within this long-range disordered structure can occur and is observed as broad peaks in the XRD pattern. The powder may then be further processed into a form useful as a Li-ion (or Na-ion) battery electrode.

Key components of the method include 1) the use of microwave radiation to quickly heat precursors, instigating a reaction to form the product at high temperatures, and 2) the rapid quenching of the heated powders (e.g., in water) to ensure a pure final product. Conventional methods of synthesizing DRX involve either sintering/calcinating precursors at ≥1000 °C for ≥10 hours, or ball milling precursors at ~500 rpm for 40 hours. These conventional techniques are time and energy intensive, whereas the inventive rapid microwave technique is two orders of magnitude faster and provides significant time and energy savings. Additionally, microwave synthesis does not require an inert atmosphere to produce pure DRX (unlike the solid-state and mechanochemical milling methods), adding to the scalability and cost-effectiveness of the inventive method for commercial/industrial manufacturing of electrodes.

Example DRX lithium metal oxides/oxyfluorides manufacturable by the inventive methods described herein include those having a cation-disordered rocksalt structure and the general formula: LiₓM′_{y}M″_{2-x-y}O_{2-z}F_{z}, where 1.05≤x≤1.35, 0.1≤y≤0.9 and 0≤z≤0.7, M′ is a low-valent (e.g., ≤3+) transition metal and M″ is a high-valent (e.g., ≥4+) transition metal. M′ is chosen from at least one of V, Cr, Mn, Fe, Co, Ni, Mg, Cu, Al, and M″ is chosen from at least one of Ti⁴⁺, Zr⁴⁺, Nb⁵⁺, V⁵⁺, M₀⁶⁺.

DRX products obtained from the inventive microwave synthesis may exhibit similarly advantageous structural and electrochemical properties as those formed via conventional solid-state synthesis, though are obtained at a fraction of the typical synthetic time, energy, and cost. Moreover, the inventive microwave synthesis produces particles with improved particle morphology, including smaller and more uniform particle sizes, as compared to solid-state and mechanochemical synthesis methods.

### BRIEF DESCRIPTION OF THE DRAWINGS

Further features and advantages of the invention can be ascertained from the following detailed description that is provided in connection with the drawings described below, in which like reference numbers represent corresponding parts throughout:

FIG. 1 provides a flowchart illustrating a method according to the present invention for making a disordered rocksalt oxide/oxyfluoride (DRX) ionic compound.

FIG. 2 shows examples of rocksalt-type oxide crystal structures, including: (a) a disordered rocksalt structure in which all cation sites are equivalent (e.g., α-LiFeO₂); (b) a layered structure (e.g., α-NaFeO₂); (c) a spinel-like, low-temperature structure (e.g., LT-LiCoO₂); and (d) a γ-LiFeO₂ structure. Large empty circles indicate anion (e.g., oxygen) sites, small gray and black filled circles stand for cation sites (e.g., alkali metal/lithium and transition metal sites, respectively). Gray/black half circles represent cation sites that are equivalent and can be occupied by alkali metal atoms or transition metal atoms.⁶⁻⁷

FIG. 3 shows properties of Li—Mn—Ti—O (LMTO) DRX obtained via microwave heating (mw) for 5, 10, and 20 minutes, and via solid-state (ss) synthesis with a 12 hr calcination step at >1000 °C, including: (a) Synchrotron X-Ray Diffraction (SXRD), λ=0.24101 Å, of as-synthesized DRX powders; (b) scanning electron microscope (SEM) images of as-synthesized DRX particles; and (c) SEM images of DRX ball-milled with Super C65 conductive additive.

FIG. 4 shows properties of LMTO, including: (a) ⁷Li pj-MATPASS; (b) ¹⁹F spin echo solid-state NMR spectra collected on mw-LMTO with a short interscan delay (50 ms) and a T2 filter (15 rotor period delay) in order to suppress the 19F probe background signal; and (c) ¹⁹F spin echo solid-state NMR spectra collected on mw-LMTO with a long interscan delay (20 sec) to better quantify the LiF impurity signal.

FIG. 5 shows properties of LMTO, including: (a) Mn K-edge X-ray Absorption Near Edge Spectroscopy (XANES) of mw- and ss-LMTO along with Mn₂O₃ and MnO₂ reference samples; (b) X-ray PDF boxcar fits of mw-LMTO DRX; and (c) X-ray PDF boxcar fits of ss-LMTO DRX. Fits are shown for two space groups: the cubic 225 structure that corresponds to a fully random arrangement of cations in the DRX structure, and the tetragonal 141 structure that represents preferential cation ordering within the DRX structure. Fits were performed over various r ranges and indicate that the cubic DRX structural model best fits the experimental data over long correlation lengths r, but the tetragonal structure best fits the data over short correlation lengths r. The mw-LMTO sample was obtained with a 5 min microwave heating step.

FIG. 6 shows Galvanostatic cycling plots of synthesized LMTO, including: (a) LMTO synthesized via solid-state methods; (b) LMTO synthesized via microwave methods; (c) differential capacity plots obtained during the first five cycles; (d) evolution of the discharge capacity and coulombic efficiency of ss- and mw-LMTO DRX cathodes over 50 cycles; and (e) rate capabilities of ss- and mw-LMTO DRX cathodes, with a rate value displayed on the graph in units of mA/g. The mw-LMTO sample was obtained with a 5 min microwave heating step.

FIG. 7 shows: (a) Synchrotron XRD (λ=0.24101 Å) of Li—Mn—Nb—O—F (LMNO/F) DRX synthesized via microwave heating (mw) for 5, 10, and 20 minutes, and via solid-state (ss) synthesis with a 12 hr calcination step at >1000 °C, and SEM images of (b) as-synthesized DRX particles, and (c) DRX ball-milled with Super C65.

FIG. 8 shows: (a) ⁷Li pj-MATPASS NMR spectra of LMNO/F; (b) ¹⁹F NMR spin echo spectra of mw-LMNO/F and mw-LMTO, collected with a short interscan delay (50 ms) and a T2 filter (15 rotor period delay) in order to suppress the 19F probe background signal; and (c) ¹⁹F NMR spin echo spectra of mw-LMNO/F and mw-LMTO, collected with a long interscan delay (20 sec) to better quantify the LiF impurity signal.

FIG. 9 shows: Mn K-edge XANES of mw- and ss-LMNO/F along with Mn₂O₃ and MnO₂ reference samples. The mw-LMNO/F sample was obtained with a 5 min microwave heating step.

FIG. 10 shows: (a) galvanostatic cycling plots of LMNO/F synthesized via solid-state methods; (b) galvanostatic cycling plots of LMNO/F synthesized via microwave methods; (c) differential capacity plots obtained during the first five cycles; (d) evolution of the discharge capacity and coulombic efficiency of ss- and mw-LMNO/F DRX cathodes over 50 cycles; and (e) rate capacities of ss- and mw-LMNO/F DRX cathodes, with rate value displayed on the graph in units of mA/g. The mw-LMNO/F sample was obtained with a 5 min microwave heating step.

FIG. 11 shows: (a)-(c) ¹⁹F solid-state NMR spectra of mw-LMTO and LMTO/F, synthesized with and without Li excess, respectively, with varying microwave heating times, with spectra shown in (a) and (c) obtained with short recycle delays (50 ms), and spectra shown in (b) acquired at long recycle delays (20 s); and (d) ¹⁹F spectra of a 5-minute mw-LMTO/F composition compared to LMNO/F samples obtained after varying microwave heating times, indicating that Nb-based DRX are still more fluorinated.

FIG. 12 shows ¹⁹F NMR with short (50 ms) recycle delays for: (a) Li_{1.2}M n_{0.5}Ti_{0.3}O_{1.8}F_{0.2}, and (b) various LMTO/F and LMNO/F DRX compositions.

FIG. 13a shows SEM image of LMTO sample synthesized via conventional solid-state synthesis wherein the precursor powder mixture was heated at a high temperature (>1000 °C) under an Ar flow for 12 hours, according to the description in the second example.

FIG. 13b shows SEM image of LMTO sample synthesized via the microwave synthesis method of the present invention, after 5 minutes of microwaving and according to the description in the first example.

FIG. 14a shows particle size plots for the LMTO particles in the SEM image of FIG. 13a (conventional solid-state synthesis), wherein the largest diameter of each of 814 of the particles in the image were measured using a ruler tool provided by a software package. No weighting factor was applied.

FIG. 14b shows particle size plots for the LMTO particles in the SEM image of FIG. 13b (microwave synthesis), wherein the largest diameter of each of 1500 of the particles in the image were measured using a ruler tool provided by a software package. No weighting factor was applied.

FIG. 15 shows particle size distribution data for powder LMTO samples synthesized via solid-state and microwave methods, obtained with a PSD analyzer, for which the SEM images in FIGS. 13a-13b are representative.

### DETAILED DESCRIPTION OF THE INVENTION

In the following description, reference is made to the accompanying drawings which form a part hereof, and in which is shown one or more manners or practicing the present invention. It is to be understood that other embodiments may be utilized, and structural changes may be made, without departing from the scope of the present invention.

The use of examples or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

The word “substantially”, as used herein with respect to any property or circumstance, refers to a degree of deviation that is sufficiently small to not appreciably detract from the identified property or circumstance. The exact degree of deviation allowable in each circumstance will depend on the specific context, as would be understood by one having ordinary skill in the art.

Use of the terms “about” or “approximately” are intended to describe values above and/or below a stated value or range, as would be understood by one having ordinary skill in the art in the respective context. In some instances, this may encompass values in a range of approximately +/−10%; in other instances, there may be encompassed values in a range of approximately +/−5%; in yet other instances values in a range of approximately +/−2% may be encompassed; and in yet further instances, this may encompass values in a range of approximately +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

The term “transition metals” as used herein is intended to describe metals in the d-block (Groups 3-12) of the periodic table and other metals which perform an equivalent role in lithium (transition) metal oxide cathode materials. These elements may play either an active role in electrochemical processes by oxidation or reduction or remain in a fixed oxidation state. Some representative examples include manganese and titanium. Other metals which are not “transition metals” in the traditional context may be encompassed under this term due to serving a similar purpose in the material as electrochemically inert metals such as Ti, and it will therefore be understood that metals outside the d-block may be included in the DRX formulation and referred to as “transition metals” in some instances.

Recitations of value ranges herein, unless indicated otherwise, serve as shorthand for referring individually to each separate value falling within the respective ranges, including the endpoints of the range, each separate value within the range, and all intermediate ranges subsumed by the overall range, with each incorporated into the specification as if individually recited herein.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

The present disclosure reports on a method for the rapid synthesis of cation disordered ionic compounds, e.g., rocksalt-type oxides/oxyfluorides (DRX), that can be used as high energy-density, sustainable and low-cost electrode (e.g., cathode) materials, for example, in Li-ion rechargeable batteries. As described herein, the method comprises microwave heating a precursor (e.g., for 5-20 minutes under ambient atmosphere) followed by a rapid quench. The method is scalable for commercial/industrial scale manufacturing of electrodes. Example materials that may be manufactured via microwave synthesis include, but are not limited to, DRX oxides and oxyfluorides having the general formula LiₓM′_{y}M″_{2-x-y}O_{2-z}F_{z}, where 1.05≤x≤1.35, 0.1≤y≤0.9 and 0≤z≤0.7, in which M′ is a low-valent (e.g., ≤3+) transition metal chosen from at least one of V, Cr, Mn, Fe, Co, Ni, Mg, Cu, Al and M″ is a high-valent (e.g., ≥4+) transition metal chosen from at least one of Ti⁴⁺, Zr⁴⁺, Nb⁵⁺, V⁵⁺, Mo⁶⁺.

Following are examples illustrating various embodiments of the invention, including a comparative study of Li_{1.2}Mn_{0.4}Ti_{0.4}O₂ (LMTO) and Li_{1.3}Mn_{0.4}Nb_{0.3}O₂₋ₓFₓ (LMNO/F) synthesized by microwave (mw) and conventional solid-state (ss) methods. For fluorinated MnTi-based DRX (LMTO/F), compositions with varying transition metal stoichiometries and fluorine contents have been synthesized and characterized.

### First Example: Microwave Synthesis of DRX Oxides/Oxyfluorides

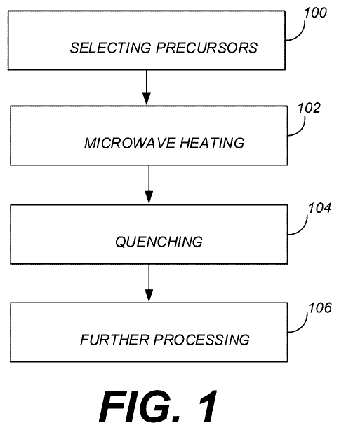

FIG. 1 shows a flowchart illustrating one example of a method for synthesizing a rocksalt composition used for the comparative study and characterizations presented herein. Block 100 represents the selection of precursor compounds and mixture thereof in the amounts needed for the desired stoichiometry. Li₂CO₃ and LiF were chosen as Li and F sources for the synthesis of LMTO and LMNO/F compounds. However, other Li- and F-containing compounds may also be used such as, but not limited to, Li₂O, LiNO₃, polytetrafluoroethylene (PTFE), etc. Mn₂O₃ was chosen as the redox active transition metal precursor. In general, an oxide of the transition metal of interest may be selected. TiO₂ and Nb₂O₅ were chosen as the d⁰ metals for LMTO and LMNO/F. Again, an oxide of the metal of interest may typically be selected.

For microwave synthesis of LMTO, precursor powders of Li₂CO₃, LiF, Mn₂O₃, and TiO₂ were measured out such that the Mn, Ti, and F stoichiometries matched the chemical composition of the formula Li_{1.2}Mn_{0.4}Ti_{0.4}O_{1.9}F_{0.1}. For Li₂CO₃, 10% molar excess was measured out to compensate for possible Li loss during the heating process. LiF was added in sufficient quantity to provide approximately 5% fluorination, as a sintering agent to allow for faster diffusion of elements during synthesis.

For microwave synthesis of LMNO/F, precursor powders of Li₂CO₃, LiF, Mn₂O₃, and Nb₂O₅ were measured out such that the Li, Mn, Nb, and F stoichiometries matched the chemical composition of the formula Li_{1.3}Mn_{0.4}Nb_{0.3}O_{1.9}F_{0.1}. Again, approximately 5% fluorine content was added as a sintering agent. No Li excess was added for LMNO/F.

For microwave synthesis of fluorinated MnTi DRX, precursor powders of Li₂CO₃, LiF, Mn₂O₃ and TiO₂ were measured out such that the Li, Mn, Ti, and F stoichiometries matched the targeted composition. No Li excess was added.

The precursors may also be prepared in other forms, for example, pellet form. For the results presented herein, once precursor powders were measured out, they were ground by hand until sufficiently homogenous, and pressed into 200 mg pellets.

Block 102 represents microwave heating of precursor pellets. For the results presented herein, a double crucible setup was arranged, whereby a smaller (e.g., alumina) crucible was placed in the center of (or inside) a larger crucible, and a heat transfer medium (e.g., activated carbon) was added to the larger crucible to surround the smaller inner crucible. A layer of sacrificial precursor powder was added to the small crucible, and the precursor (e.g., pellet) was carefully placed on top of the sacrificial powder in the smaller crucible. The setup was placed into a 1200 Watt conventional microwave in an ambient atmosphere and irradiated with microwaves at a set power level (6) and time (5-20 minutes). The activated carbon heats up by resonating with the microwaves, so that the pellet may be initially heated via a conductive process, e.g., interdiffusion, wherein heat is transferred from the activated carbon to the pellet via heat conduction. The activated carbon may be placed in physical contact with the pellet to enhance this process. Above a critical temperature however, the pellet material becomes susceptible to microwave irradiation, so that heating occurs via direct interaction of the pellet with the microwaves, leading to very high reaction temperatures (>1500 °C, preferably >1600 °C) in a short period of time (e.g., 5-20 minutes). During this time, the DRX phase forms.

Block 104 represents quenching. For the results presented herein, the pellet was rapidly quenched in distilled water immediately after the end of the microwave heating. The quenching process enables the high temperature DRX phase to be stabilized at room temperature, while preventing the formation of any layered/ordered oxide impurities during the cooling process. In some examples, quenching may be performed with mediums other than distilled water, such as ethanol or liquid nitrogen.

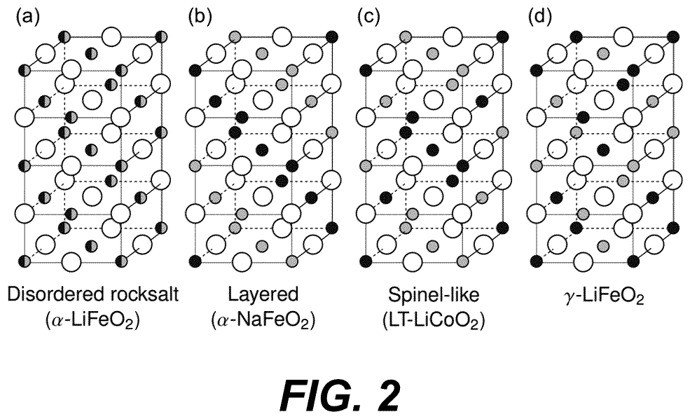

Block 106 represents further processing. For the results presented herein, the pellet was dried on a hotplate and ground to obtain a fine powder of the final DRX product. FIGS. 2a-2d illustrate examples of ionic lattices of compositions of matter that may be fabricated using the method of FIG. 1, illustrating the disordered arrangement of cations on lattice sites.

### Second Example: Conventional Solid-State Synthesis of LMTO and LMNO/F

A Li_{1.2}Mn_{0.4}Ti_{0.4}O₂ composition was synthesized for ss-LMTO, and a Li_{1.3}Mn_{0.4}Nb_{0.3}O₂ composition was synthesized for ss-LMNO. Li₂CO₃, Mn₂O₃, and either TiO₂ (LMTO) or Nb₂O₅ (LMNO/F) were used as precursors for solid-state synthesis. For LMTO, stoichiometric amounts of Mn and Ti, and 10% molar excess of Li were used. For LMNO/F, stoichiometric amounts of Mn, Nb, and Li were used, but no Li excess was added.

As for the solid-state synthesis, precursors were ground and pressed into ~200 mg pellets. Pellets were annealed for 12 hours at 1100 °C under Ar flow and allowed to slowly cool to room temperature, and gently ground to result in the final ss-DRX powder. This procedure is similar to those reported in the literature for solid-state synthesis of similar disordered oxide compositions.

### Third Example: Characterization of LMTO Obtained Using Synthesis Methods Described in the First and Second Examples

### (a) Structural Characterization

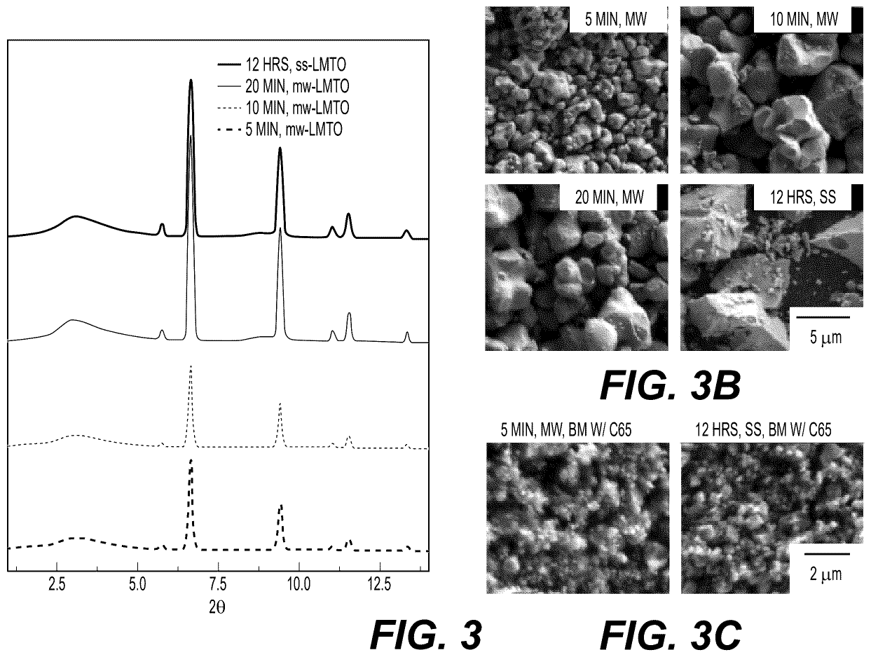

FIG. 3a shows Synchrotron X-Ray Diffraction (SXRD) data indicating the formation of phase-pure LMTO DRX obtained via microwave (5, 10, 20 min) and conventional solid-state (12 hours) synthesis methods. Broad, low angle (~3° in 2θ) peaks indicate the presence of cation short-range ordering. Although the mw-LMTO DRX was obtained after a fast quench, those SXRD results indicate that a similar degree of cation short-range order is present in this material compared to the LMTO DRX compound obtained via conventional solid-state synthesis (1000 °C sintering followed by a slow cool).

SEM micrographs in FIGS. 3b-3c indicate the presence of large crystalline DRX particles in all the as-synthesized LMTO samples. The average particle size depends on the microwave heating time. After 5 mins of heating, particles are on the order of ~1 μm. After 10 and 20 mins of heating time, particles are on the order of ~3-5 μm. mw-DRX compounds have smaller and more uniform particle sizes compared to ss-DRX compounds.

### (b) Compositional Analysis of the Compositions Obtained Using Synthesis Methods Described in the First and Second Examples

TABLE 1

| LMTO Sample | Li | DRX Li | Mn | Ti | F | % Li impurity |
|---|---|---|---|---|---|---|
| mw, 5 min | 1.310 | 1.14 | 0.4 | 0.392 | 0.055 | 12.6 |
| mw, 10 min | 1.277 | 1.14 | 0.4 | 0.391 | 0.042 | 10.5 |
| mw, 20 min | 1.278 | 1.15 | 0.4 | 0.394 | 0.032 | 9.8 |
| ss, 12 hr | 1.277 | 1.15 | 0.4 | 0.398 | 0.001 | 9.8 |

Stoichiometries obtained from ICP, F-ISE and ⁷Li solid-state NMR, normalized to Mn. DRX Li refers to Li that is only in a DRX-like environment. The % Li impurity corresponds to the Li molar fraction contained within diamagnetic impurity phases.

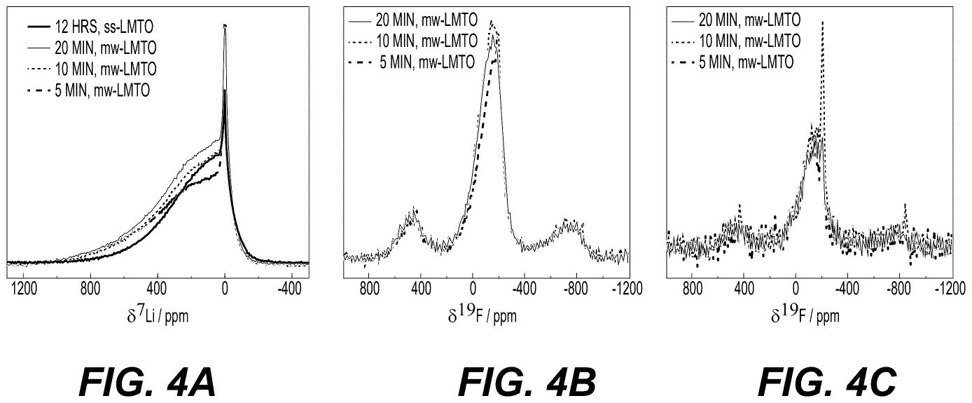

The ratio of Li, Mn, Ti, and F in the samples were determined by Inductively Coupled Plasma (ICP). The presence of amorphous Li-containing impurity phases, such as LiF and Li₂CO₃, prevent the determination of the DRX stoichiometry using SXRD and ICP alone. ⁷Li solid-state Nuclear Magnetic Resonance (NMR) can detect amorphous phases and provide quantitative information on the molar ratio of Li in the LMTO DRX phase versus Li present in amorphous and crystalline diamagnetic impurities (see FIG. 4a). The narrow peak at 0 ppm is associated with diamagnetic Li impurities (LIF, Li₂CO₃), while the broad and asymmetric signal is associated with Li in a range of local environments within the disordered and paramagnetic LMTO DRX phase.

Fully relaxed spin-echo ⁷Li spectra were fit with four paramagnetic gaussian components to model a disordered environment and a single diamagnetic 50% Lorentzian component. Integration of the model gives an upper bound on the amount of Li impurities present; this value slightly underestimates the amount of Li in the DRX because Li is near paramagnetic Mn³⁺, resulting in fast NMR signal decay. However, this effect is relatively small.

Li impurity quantification shows that, as the microwave heating time increases, the fraction of Li in diamagnetic impurity phases decreases. After 20 min of heating time, the molar fraction of Li in diamagnetic impurities in the mw-LMTO sample is equal to that present in the LMTO sample obtained via conventional solid-state synthesis (12 h sintering step). Longer reaction times volatilize the excess Li, resulting in fewer impurities.

By combining ICP and ⁷Li NMR, the Li stoichiometry of the LMTO DRX phase can be obtained. As seen in Table 1 all DRX samples, regardless of the synthesis method and time, have very similar Li stoichiometries of 1.14-1.15. Note again that this is a lower bound for Li in the DRX, as the amount of Li is underestimated by ⁷Li NMR.

The ⁷Li solid-state NMR signals associated with the mw-LMTO phases obtained after heating for 5, 10 and 20 min are very similar, but the ⁷Li signal associated with the LMTO phase prepared via solid-state synthesis is slightly different, indicating slight differences in the distribution of local Li environments in the latter sample.

In one or more examples, LiF acts as a sintering agent in the microwave synthesis process.

TABLE 2
Molar fraction of F present in LiF impurity phases/domains in LMTO
DRX samples, obtained from fits of ¹⁹F solid-state NMR spectra.

| Sample | % LiF impurity |
|---|---|
| mw, 5 min | 39 |
| mw, 10 min | 34 |
| mw, 20 min | 8 |

Fluoride Ion Selective Electrode (F-ISE) results show that even for a fast, 5-minute reaction time, roughly half of the fluorine that was originally present in the precursor is lost. This indicates that for mw-LMTO, minimal fluorination occurs. Furthermore, as with ICP, F-ISE cannot differentiate between fluorine present in the DRX and as LiF impurities, such that the DRX fluorination level may be even lower. X-ray and neutron diffraction techniques are unable to distinguish F from O, due to the similar scattering cross sections of the two elements. ¹⁹F NMR, on the other hand, is an effective probe of F species present in DRX and potential LiF phases/domains. The sharp ¹⁹F ss-NMR signal centered at −204 ppm corresponds to LiF impurity phases/domains, while F in the DRX structure leads to the broad and asymmetric signal in FIGS. 4b-4c.

The ¹⁹F NMR spectra acquired using a fast (50 ms) and a slow (20 sec) recycle delay are shown in FIGS. 4b-4c, respectively. While a short recycle delay enables the acquisition of a large number of scans (48k) for signal averaging, and the obtention of spectra with a high signal to noise ratio in a reasonable amount of time, it also results in truncation of the slowly relaxing LiF signal at −204 ppm. The spectrum obtained with a longer recycle delay of 20 sec thus provides more quantitative information on the amount of LiF phases/domains in the sample.

The ¹⁹F spectra collected here are only semi-quantitative as part of the F incorporated into the DRX cathode (F directly bonded to paramagnetic M n) cannot be observed experimentally. However, the poor signal to noise ratio observed for the 19F spectrum obtained with a fast recycle delay (FIG. 4b), even after 48k scans, provides further indication that there is very little F incorporated into the DRX phase.

From the 19F spectra obtained with a slow recycle delay (20 sec) and shown in FIG. 4c, it is clear that the diamagnetic LiF impurity peak at −204 ppm is quite significant. Fits of the 19F spectrum collected on the mw-LMTO sample synthesized using a 5-minute microwave heating step show that the very small amount of fluorine present in this sample is largely incorporated into an LiF impurity phase (39 fluorine mol %). Note that this value is an overestimate (upper bound) for the fraction of LiF in the sample, as part of the 19F NMR signal from the DRX cathode is not visible experimentally. Increasing the microwave heating time to 10 and 20 minutes reduces the amount of LiF impurities, but also reduces the total amount of F in the DRX sample, as seen by the decreasing intensity of the broad paramagnetic signal.

There is overall very little F incorporated into the DRX phase, and F from the LiF precursor is better described as a sintering agent than as a precursor in the synthesis of LMTO.

### (c) Analysis of Local and Electronic Structures of LMTO

### (i) Mn K-Edge XAS

Mn K-edge X-ray Absorption Spectroscopy (XAS) data was acquired to probe differences in the local coordinations and oxidation states of M n species in the mw- and ss-LMTO DRX compounds of interest. XANES edge energy shifts show that mw-LMTO has a slightly higher average Mn oxidation state than ss-LMTO. The slightly higher Min oxidation state observed for the microwave sample is most likely due to the more oxidizing ambient air environment used for microwave synthesis, as compared to the inert Ar atmosphere used for solid-state synthesis.

### (ii) X-Ray PDF Analysis

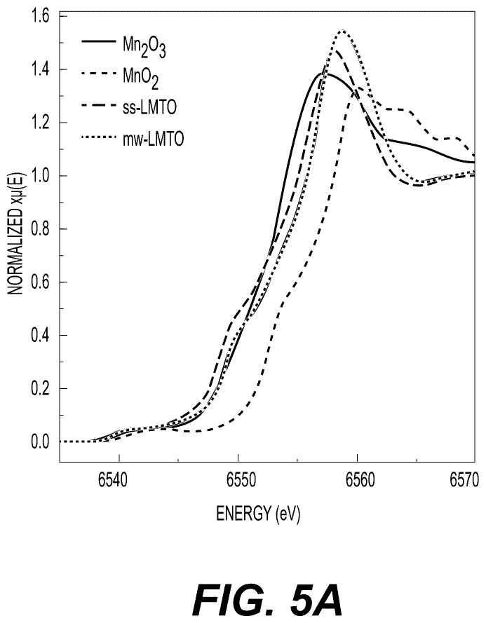

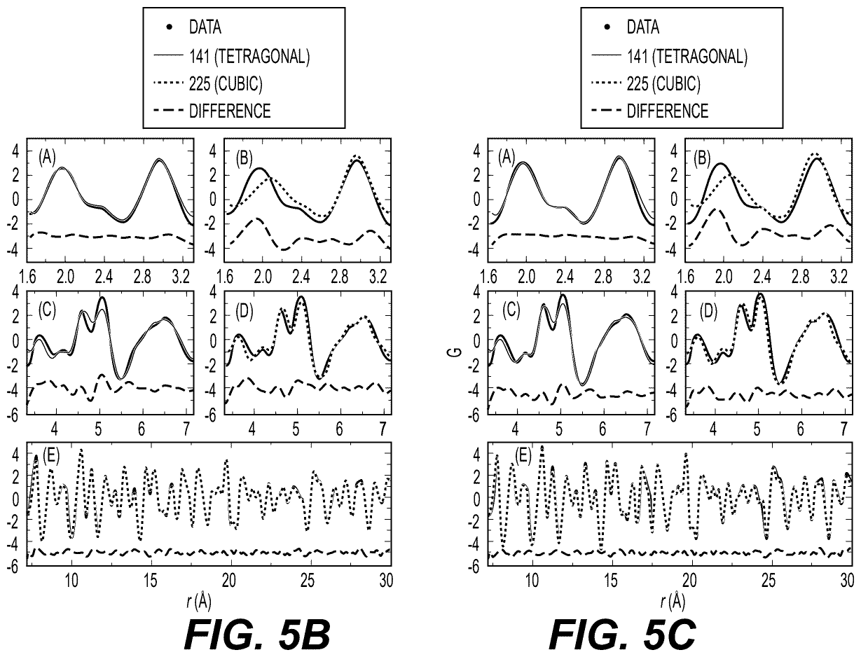

X-ray Pair Distribution Function (PDF) analysis provides information about short-range ordering, which heavily influences Li-ion transport and thus the electrochemical performance of DRX cathodes. PDF analysis was carried out on SXRD data collected on the mw- and ss-LMTO compounds using two different structural models: a cubic rocksalt model (space group Fm-3m, #225), corresponding to a random distribution of cations, and a tetragonal model (space group/4₁/amd, #141) that represents an ordered cation arrangement. The results are shown in FIG. 5.

For both models, fits were performed over varying correlation lengths r, to see how the DRX structure evolves from short- to long-range. Over long correlation lengths, the cubic 225 space group provides the best fit of the data, consistent with the SXRD results and with the description of those compounds as cation disordered on average.

However, over shorter correlation lengths (1.6-3.2 A), FIG. 5 clearly shows that a cubic structure results in a poor fit. Instead, the tetragonal 141 space group provides a much better fit, indicating that short-range ordering of the cations exists.

In both the mw- and ss-LMTO DRX structures, the transition from short-range cation order to a disordered cation arrangement on the long-range occurs at a similar correlation length r, indicating there is not much difference in the degree of cation short-range order when the DRX is synthesized using these two methods.

### (d) Electrochemistry of Ss- and Mw-LMTO

DRX samples synthesized via microwave (with a 5 min heating step) and solid-state methods were post-processed in the same way: the DRX powder was mixed with Super C65 in a 70:20 mass ratio in a planetary ball mill at 400 rpm for 6 hours in order to reduce particle size and to carbon coat the active material to improve its ionic and electronic conductivity.

SEM images (FIG. 3c) show that both solid-state and microwave post-processed particles are of the same size, such that differences in electrochemical performance can be attributed to the active material's composition and bulk structure or the presence of impurity phases.

DRX+Super C65 powder was further mixed with PTFE to yield a material: carbon: binder weight ratio of 70:20:10. Thin cathode films were rolled out, with a loading of 4 to 5 mg/cm². CR 2023 type coin cells were assembled using the cathode film, Li metal anode, a Celgard 2325 trilayer membrane, and commercial 1M LiPF₆ salt in 1:1 EC:DMC solvent as electrolyte.

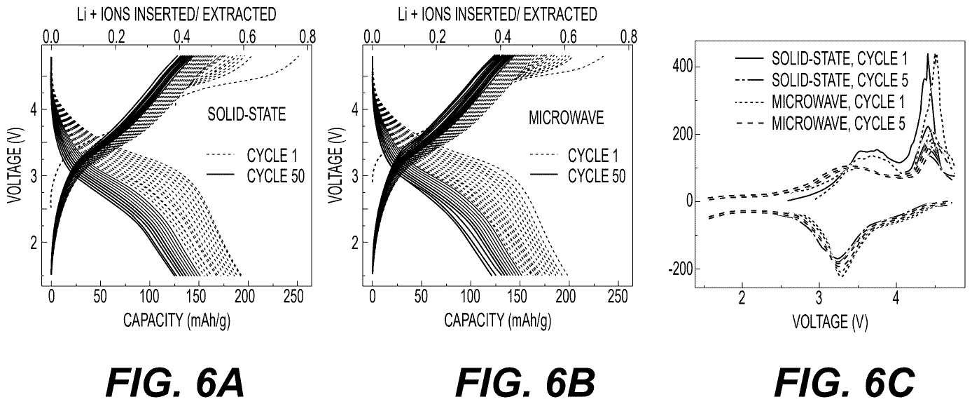

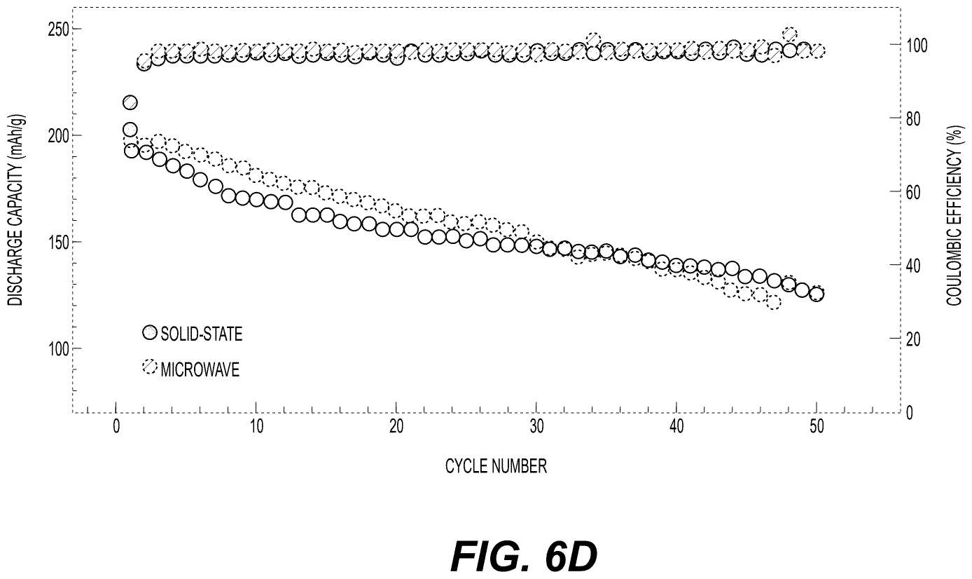

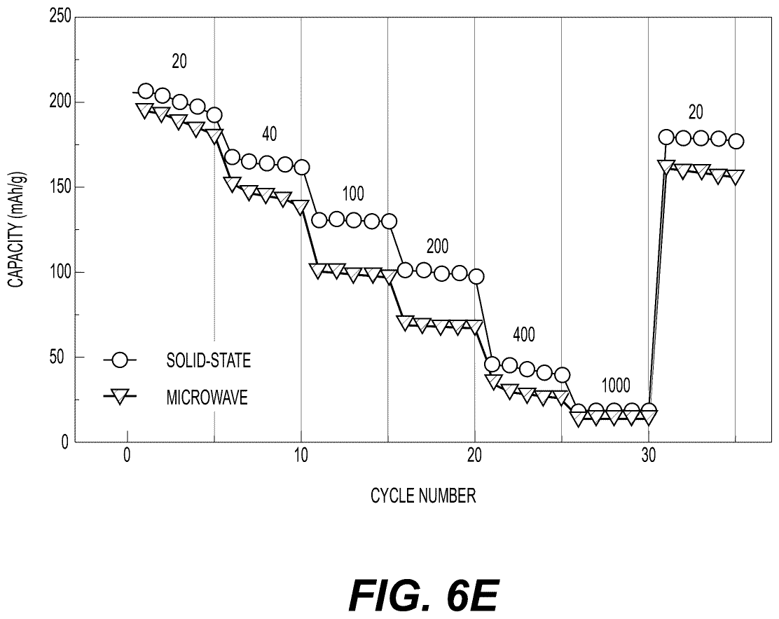

The galvanostatic profiles of ss- and mw-LMTO shown in FIGS. 6a-6b are very similar. Both exhibit an initial and 50 cycle discharge capacity of 200 mAh/g and 130 mAh/g, respectively, corresponding to a 35% capacity fade (see FIG. 6d).

The mw-DRX has a higher open-circuit voltage (OCV) than the ss-cathode (3.0V versus 2.7V), in line with the higher M n oxidation state observed in the XANES data.

Coulombic efficiencies are also identical (FIG. 6d) and remain close to ~99% throughout the first 50 cycles. Differential capacity analysis shown in FIG. 6c indicates the redox processes for ss- and mw-DRX are very similar, where the lower voltage oxidation and reduction peaks correspond to M n redox, and the higher voltage peaks to O redox. For mw-LMTO, the O oxidation peak occurs at a slightly higher voltage than for the solid-state sample.

Operating voltage, energy density, voltage retention, and voltage hysteresis are also identical for the ss- and mw-LMTO cathodes. FIG. 6e shows the rate performance of LMTO cathodes and indicates that the ss-DRX performs better at higher rates. This may be due to slightly more LiF and Li₂CO₃ impurities present in the mw-DRX sample and is likely to be resolved with further fine-tuning of the microwave synthesis conditions.

### Fourth Example: Characterization of LMNO/F Obtained Using Synthesis Methods Described in the First and Second Examples

The microwave synthesis method can be applied to other DRX compositions, such as Nb-based Li_{1.3}Mn_{0.4}Nb_{0.3}O₂₋ₓFₓ (LMNO/F). Here, no Li excess was used during the microwave synthesis, which contrasts with the 10% molar excess Li used in the synthesis of the LMTO system discussed in the third example.

An LMNO composition was also prepared by conventional solid-state synthesis for comparison. A gain, a phase-pure DRX (based on synchrotron XRD) is obtained through microwave heating (and through conventional solid-state synthesis), and the particle size can be tuned by modulating the microwave heating time between 5 and 20 mins.

TABLE 3
Molar fraction of Li contained in diamagnetic
impurity phases/domains for LMNO/F, as obtained from
fits of ⁷Li solid-state NMR spectra.

| LMNO/F Sample | % diamagnetic Li impurity |
|---|---|
| ss, 12 hours | 15.2 |
| mw, 5 min | 19.2 |
| mw, 10 min | 17 |
| mw, 20 min | 15.8 |

### (a) Solid-state ⁷Li/¹⁹F NMR

ICP analysis is not typically undertaken for DRX compounds such as LMNO/F because acid digestion is notoriously difficult for Nb-containing compounds. ⁷Li and ¹⁹F NMR still provides valuable information on the amount of Li-containing impurity phases/domains and the extent of fluorination of the DRX.

The ⁷Li NMR spectrum collected on LMNO/F exhibits a slightly different line shape than the one obtained for LMTO, as expected from the higher average Mn oxidation state in the LMNO/F compounds (see following XANES analysis), and from the presence of different d⁰ transition metals (Nb vs Ti) that impact the local structure, as well as the type and/or extent of cation short-range order.²

The results in Table3 indicate that longer microwave heating times result in fewer diamagnetic Li impurities, and that, overall, LMNO/F has more Li impurities than LMTO.

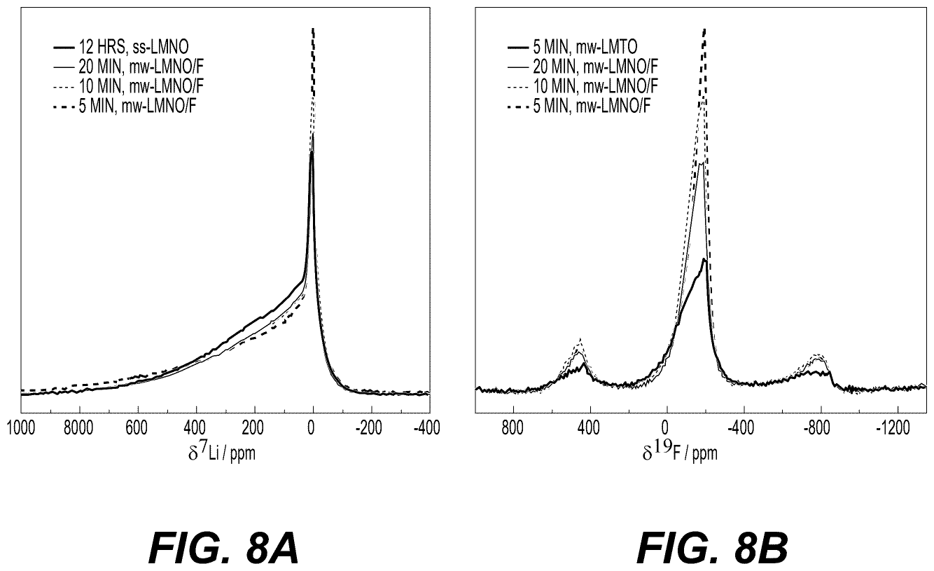

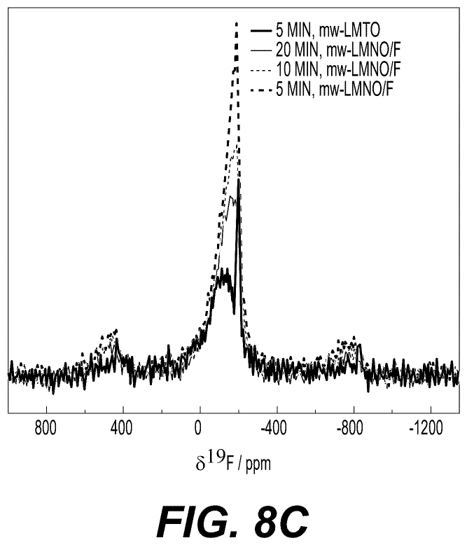

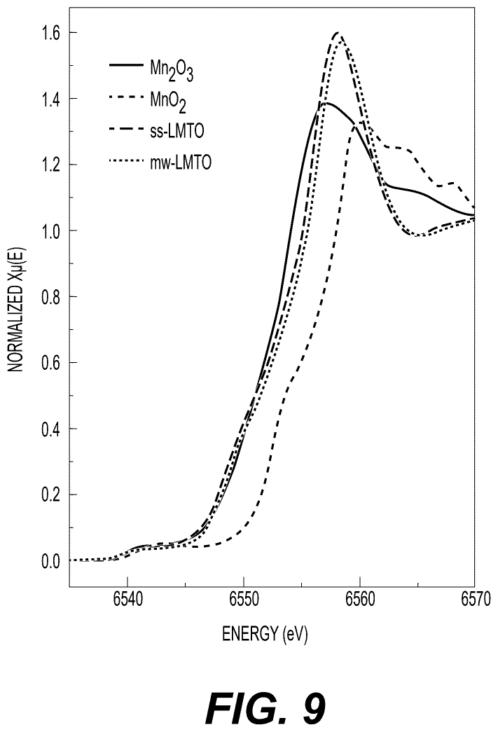

¹⁹F NMR spectra shown in FIGS. 8b-8c indicate that no LiF impurity is present in mw-LMNO/F, and that there is significantly more fluorine in DRX-like local environments in this sample compared to mw-LMTO. Thus, the mw-LMNO/F is in fact an oxyfluoride with a low F content (upper limit of fluorination is 5% based on fluorine precursor amount).

### (b) Mn K-Edge XAS and PDF Analysis

Mn K-edge XANES spectra show that the average Mn oxidation state of mw-LMNO/F is slightly higher than that of ss-LMNO/F, despite the presence of F in the microwave sample and not in the solid-state sample (F incorporation reduces the average M n oxidation state). This suggests that Li vacancies are present in the microwave sample.

PDF analysis also indicates there is no significant difference in the nature and extent of cation short-range order between LMNO/F DRX phases synthesized via microwave heating and via conventional solid-state synthesis.

### (c) Electrochemistry of Ss- and Mw-LMNO/F

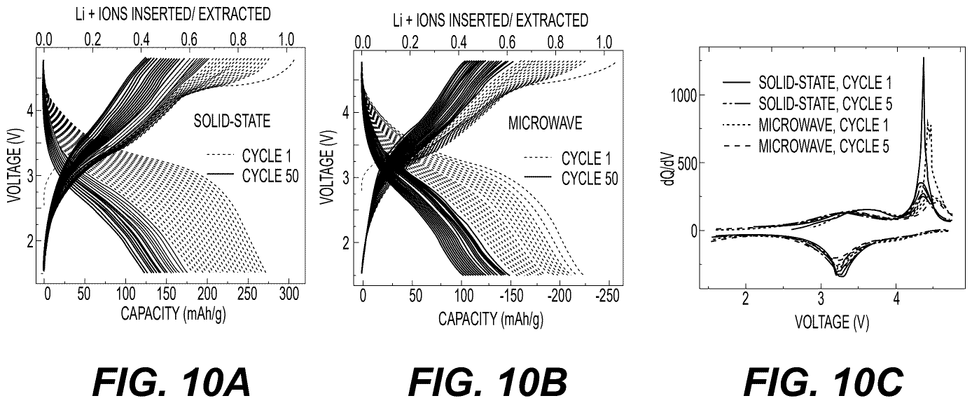

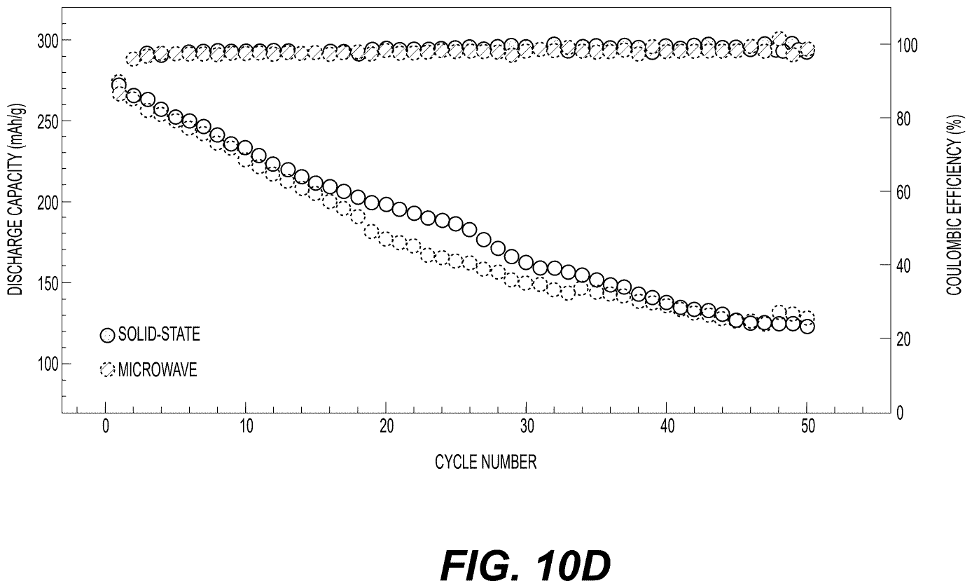

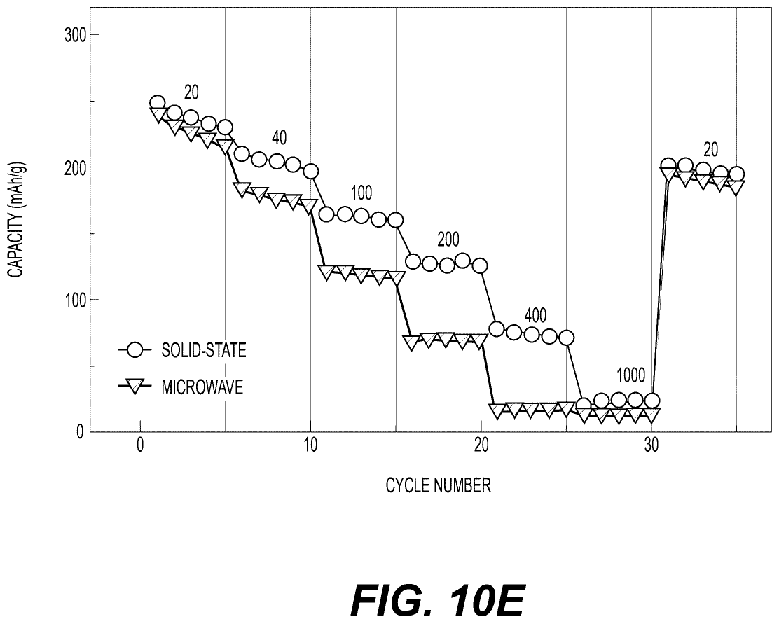

Like the LMTO system, the electrochemical properties of solid-state and microwave (with a 5 min heating step) LMNO/F are very similar (FIGS. 10a-10b). Capacities for both the mw- and ss-DR X samples evolve from 270 mAh/g during the first discharge, to 130 mA h/g after 50 charge-discharge cycles. This corresponds to a 50% capacity fade and is more severe than for the LMTO system. Energy densities and voltage fade are also comparable for mw- and ss-LMNO/F.

Coulombic efficiencies are stable at ~99%. As with LMTO, the lower voltage oxidation and reduction peaks in the differential capacity plots (FIG. 10c) correspond to M n redox, and the higher voltage peaks to O redox, with mw-LMNO/F exhibiting slightly higher voltage O redox peaks than SS-LMNO/F.

The OCV of mw-LMNO/F is higher (3.0V) than that of ss-LMNO (2.7V), in line with the higher average M n oxidation state observed with XAS.

Once again, the most significant difference between the two LMNO/F cathode samples is their rate performance, where the ss-DRX performs better, as shown in FIG. 10e. This is again likely due to the presence of a small amount of impurity phases in the microwave sample.

### Fifth Example: Fluorination of the MnTi DRX System Via Microwave Synthesis

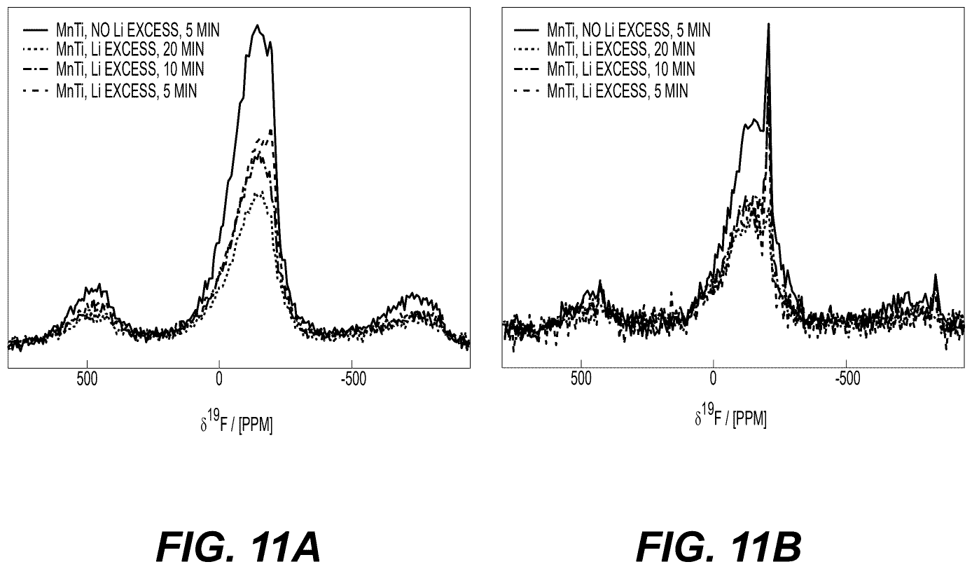

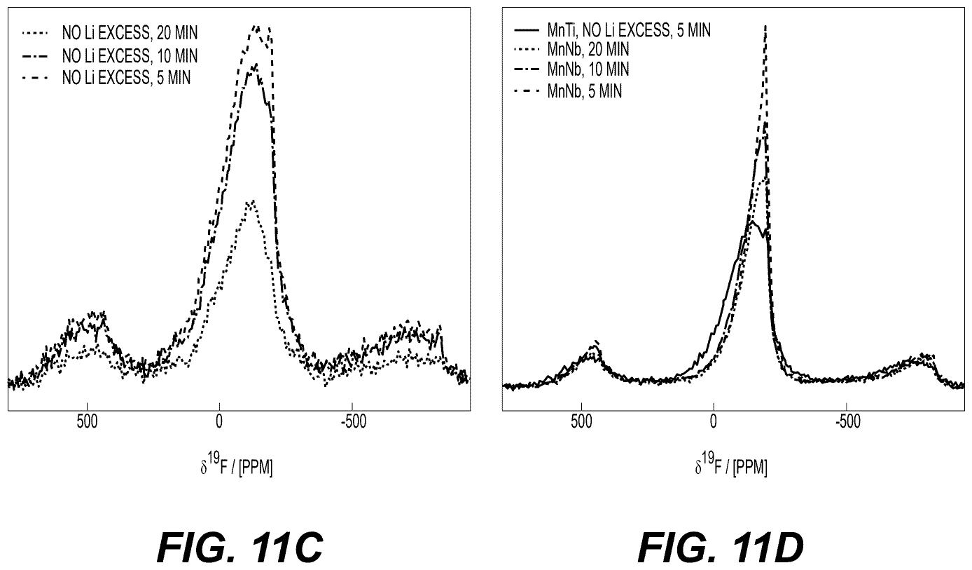

ICP and ⁷Li NMR results on LMTO indicated that Li excess is not needed to obtain a phase-pure DRX by microwave synthesis. This is presumably because Li vaporization does not occur to a significant extent with such a short (5 minute) reaction time. Hence, it was investigated whether F-containing MnTi compositions could be obtained if no Li excess were used in the precursor mixture, as it was anticipated that the Li excess may result in more volatile F and impact its incorporation into the DRX structure. The Li_{1.2}Mn_{0.4}Ti_{0.4}O_{1.9}F_{0.1} (LMTO/F) composition was targeted and prepared without Li excess, and the ¹⁹F NMR results shown in FIG. 11 suggest significant F incorporation into the bulk DRX structure. It is again noted that ¹⁹F NMR cannot be used to quantify the absolute amount of F present in the DRX phase.

Longer reaction times result in fewer LiF impurities (FIG. 11c), however at the cost of less fluorination of the DRX (consistent with LiF volatilization). Thus, fast reaction times are preferred in order to fluorinate DRX compounds.

Comparison of the ¹⁹F NMR signal intensities indicate that the mw-LMTO/F phase still contains less fluorine than the mw-LMNO/F composition (Li_{1.3}Mn_{0.4}Nb_{0.3}O_{1.9}F_{0.1}) (FIG. 11d).

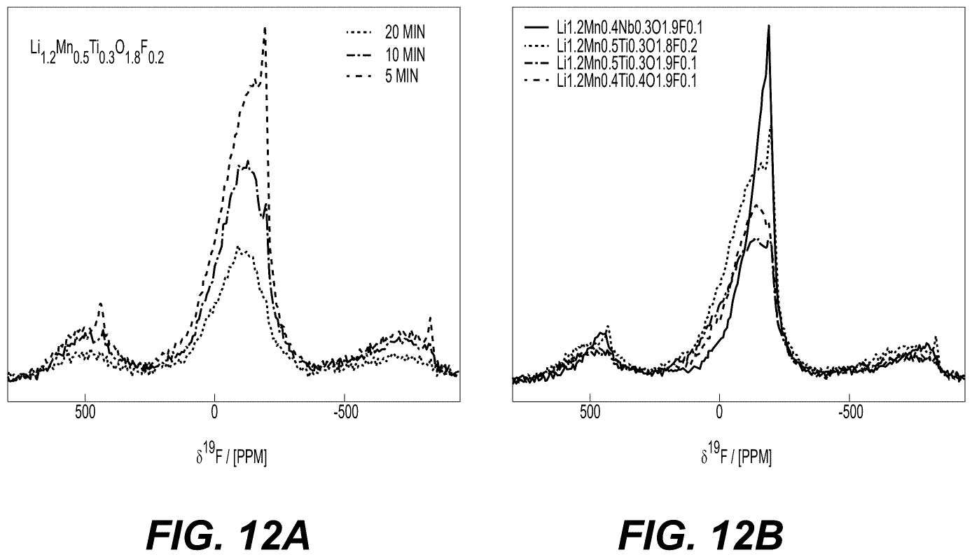

By adjusting the target DRX composition, more fluorine can be incorporated into the DRX structure (FIG. 12a). The Li_{1.2}Mn_{0.5}Ti_{0.3}O_{1.8}F_{0.2} composition contains as much fluorine as the LMNO/F (Li_{1.3}Mn_{0.4}Nb_{0.3}O_{1.9}F_{0.1}) samples (FIG. 12b). The synthesis of DRX phases with even higher F contents (Li_{1.2}Mn_{0.6}Ti_{0.2}O_{1.8}F_{0.2} and Li_{1.2}Mn_{0.7}Ti_{0.1}O_{1.7}F_{0.3}) can be optimized.

### Sixth Example: Particle Size Measurement

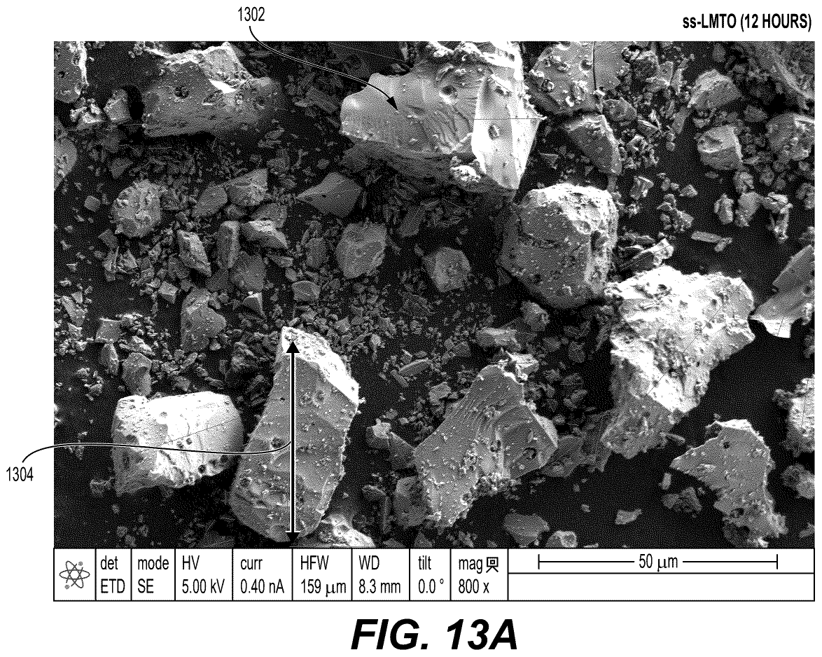

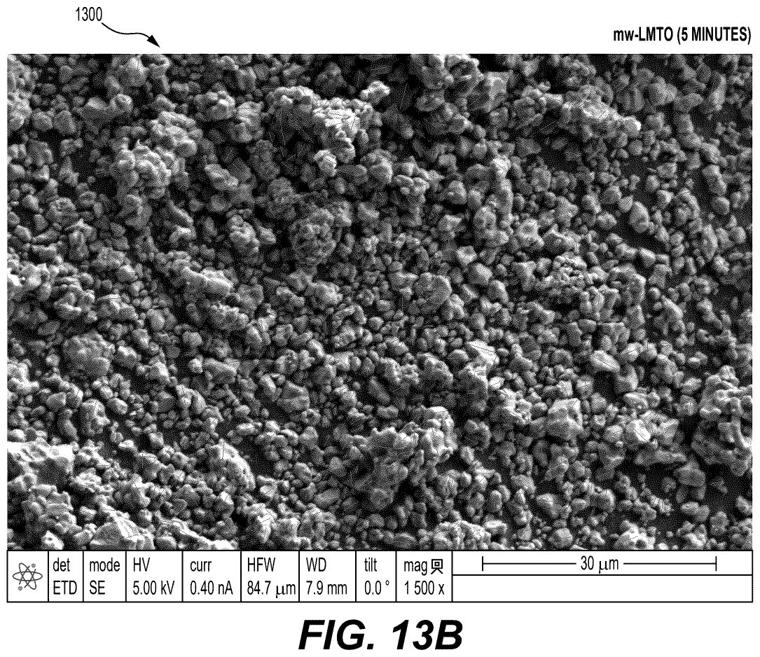

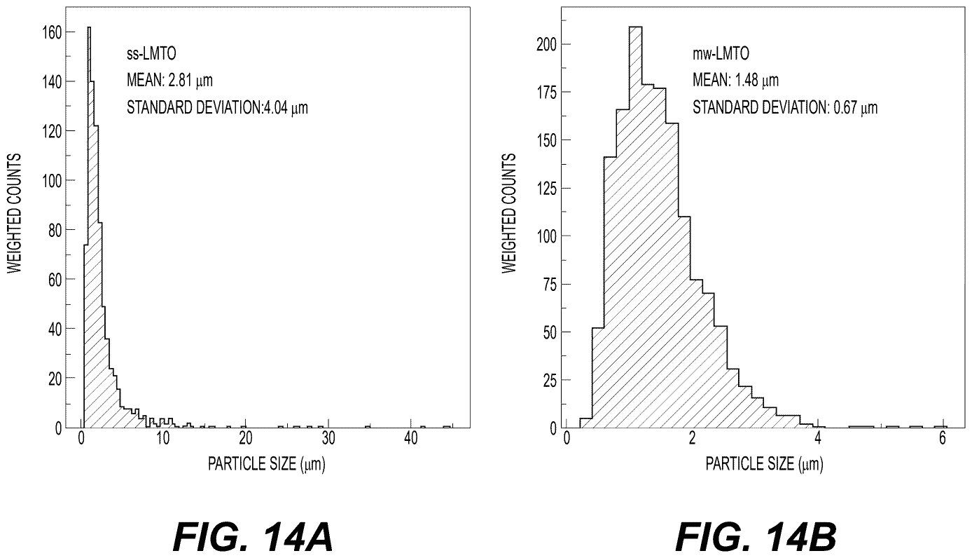

FIGS. 13a-13b are SEM images of LMTO samples synthesized via solid-state and microwave methods, respectively, showing the resulting powder 1300 comprising a lithium metal oxide/oxyfluoride compound for rechargeable batteries with a general formula: LiₓMn′yTi″_{2-x-y}O_{2-z}F_{z}, wherein 1.05≤x≤1.35, 0.1≤y≤0.9 and 0≤z≤0.7 (measured by Inductively Coupled Plasma Optical Emission Spectroscopy, ICP-OES, in Table1). The specific formulation synthesized for these samples was Li_{1.2}Mn_{0.4}Ti_{0.4}O₂ (ss-LMT44 and mw-LMT44). FIGS. 14a-14b show the particle size distributions for the particles in the powder measured in the SEM images.

The particle size distribution data in FIG. 14b shows the powder manufactured using the microwave synthesis described herein has a median particle size of at least 1.00 μm to 3 μm, with a standard deviation of no more than 1.5 μm. The median particle size of the particles 1302 was obtained by measuring the size of the particles 1302 in the SEM images along their longest dimension 1304, using the protocol described in the next section. In addition, the median particle size is measured for the particles obtained after synthesis without further processing that reduces a size of the particles.

### Seventh Example: Particle Size Measurement

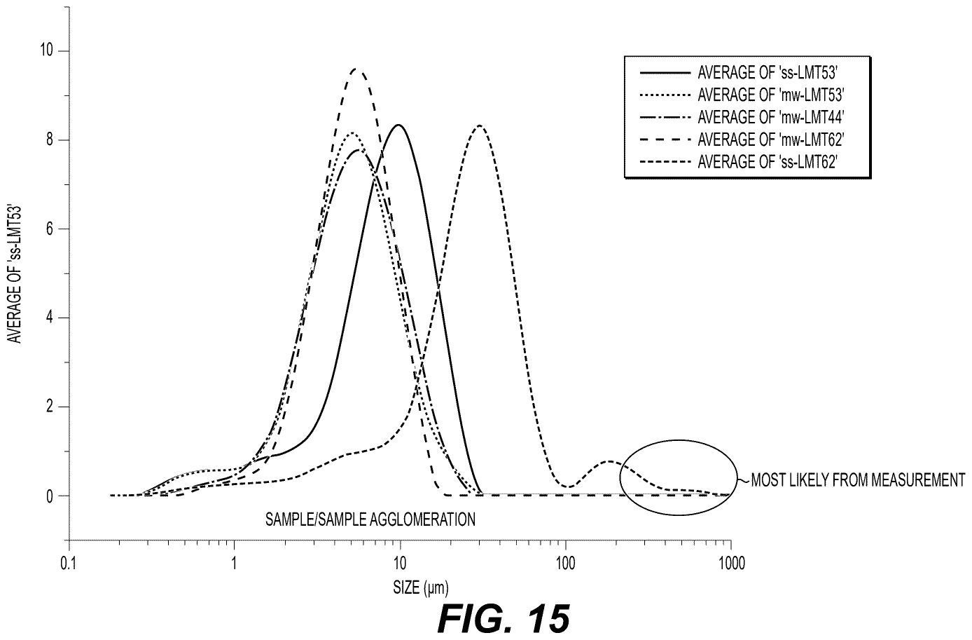

FIG. 15 provides additional particle size distribution data for particles in further powder LMTO samples synthesized via solid-state and microwave methods, for which the SEM images in FIGS. 13a-13b are again representative. The various LMTO samples are listed in the following Table 4a, with descriptions thereof following thereafter, and the particle size distribution data provided in a subsequent Table 4B, with a discussion thereof following thereafter.

TABLE 4a

| Sample Composition | Short-Name |
|---|---|
| Li_{1.2}Mn_{0.6}Ti_{0.2}O_{1.8}F_{0.2} | mw-LMT62 |
| Li_{1.2}Mn_{0.6}Ti_{0.2}O_{1.8}F_{0.2} | ss-LMT62 |
| Li_{1.2}Mn_{0.5}Ti_{0.3}O_{1.9}F_{0.1} | mw-LMT53 |
| Li_{1.2}Mn_{0.5}Ti_{0.3}O_{1.9}F_{0.1} | ss-LMT53 |
| Li_{1.2}Mn_{0.4}Ti_{0.4}O₂ | mw-LMT44 |

Samples in the foregoing Table 4a were prepared with the microwave and solid-state synthesis methods as presented in Examples 1 and 2 above. A II microwave synthesized samples were prepared with a microwave heating step having a 5-minute duration. The solid-state synthesized samples ss-LM T53 and ss-LMT62 were both prepared with calcination steps having a 12-hour duration.

TABLE 4b

| Sample | %<1 μm | %<3 μm | Dx(1) | Dx(2) | Dx(10) | Dx(50) | Dx(90) | Dx(95) | Dx(99) | Dx(100) | Span |
|---|---|---|---|---|---|---|---|---|---|---|---|
| mw-LMT62 | 0.99 | 13.62 | 1 | 2.08 | 2.68 | 5.55 | 10.4 | 12.1 | 15.2 | 18.6 | 1.394 |
| ss-LMT62 | 1.56 | 4.66 | 0.748 | 3.23 | 6.67 | 28.4 | 61.5 | 124 | 261 | 396 | 1.93 |
| mw-LMT53 | 3.93 | 19.53 | 0.514 | 1.26 | 2.11 | 5.3 | 11.7 | 14.6 | 22.1 | 34.9 | 1.804 |
| ss-LMT53 | 4.07 | 11.81 | 0.486 | 1.2 | 2.47 | 8.95 | 18 | 21 | 26.7 | 31.1 | 1.733 |
| mw-LMT44 | 1.81 | 17.3 | 0.754 | 1.71 | 2.33 | 5.68 | 12.5 | 15.2 | 20.6 | 27.3 | 1.785 |

This particle size distribution data confirms that microwave synthesis of a given composition typically yields a smaller average particle size (e.g., Dx(50)) and a more homogeneous particle size distribution (e.g., a smaller span) than that achieved by solid-state synthesis of the same given composition. According to this data, powder manufactured using microwave synthesis has a median particle size in a range of about 5.0 to about 6.0 μm (e.g., 5.3 to 5.68 μm), with 90% of the powder particles (e.g., Dx(90)) having a largest diameter in a range of about 10 μm to about 13 μm (e.g., 10.4 μm to 12.5 μm), and a particle diameter span ((Dx(90)−Dx(10))/Dx(50)) of about 1.4 to about 1.8 (e.g., 1.394 μm to 1.804 μm). These particle distributions are noticeably smaller relative to those produced from solid-state synthesis, which were found to have a median particle size in a range of about 9.0 to about 28.0 μm (e.g., 8.95 to 28.4 μm), with 90% of the powder particles (e.g., Dx(90)) having a largest diameter in a range of about 18 μm to about 62 μm (e.g., 18 μm to 61.5 μm), and a particle diameter span ((Dx(90)−Dx(10))/Dx(50)) of about 1.7 to about 1.9 (e.g., 1.733 to 1.93). It was further observed that particle distributions of the microwave synthesized powders regularly had a greater percentage of particles with largest diameters below 3 μm (e.g., “%<3 μm”).

Experimental methods and protocols used to obtain the data in the examples X-ray diffraction (FIG. 3a) and pair distribution function measurements (FIG. 5) were performed on ~40 mg samples at beamline 17-BM at the Advanced Photon Source at Argonne National Laboratory. All samples were measured at room temperature (≈303 K). Scattered intensity was measured by a Perkin Elmer amorphous-Si flat panel detector. The wavelength for the measurements was 0.24117 Å. The TOPAS software suite was used for Pawley refinements treatment of these data sets. Pair distribution function g(r) data sets were obtained by reducing image files obtained from area detector at 17-BM to .chi files using GSAS II. The .chi files were further transformed to g(r) data files using the xPD Fsuite software package 47 with a Qmax of 16.9 Å. Least-squares refinement of PDF data was performed using PDFGUI.

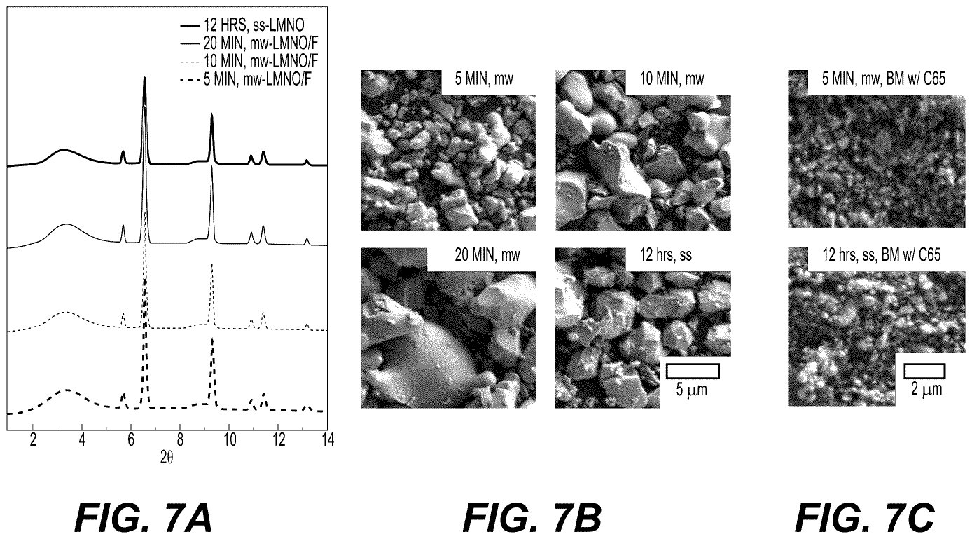

Scanning Electron Microscope (SEM) images (FIGS. 3b, 3c, 7, 13a, 13b) were obtained using a Thermo Fisher Apreo C LoVac SEM instrument with an accelerating voltage of 5 keV and current of 0.4 nA.

Bulk chemical compositions were determined using an Agilent 5800 ICP-OES, and F-ISE measurements using a Cole-Parmer system. DRX samples were digested in a mixture of nitric acid and hydrochloric acid. For ICP-OES, the digested solutions were diluted with distilled water. For F-ISE measurements, the solutions were diluted using a 23 sodium acetate buffer and a fluoride ionic strength adjuster solution (TISA B, Cole-Parmer).

The amount of Li, Mn, Ti, Nb in the positive electrode active material powder (as listed in Table 1) was measured with an ICP method by using an Agilent 5800 ICP-OES instrument. 10 mg of the powder sample was dissolved into a mixture of 4 mL concentrated nitric acid and 1 ml concentrated hydrochloric acid. Afterwards, a 1 mL aliquot of the dissolved sample solution was pipetted into a falcon tube, followed by 13 mL of distilled water, resulting in a 14× dilution by volume. The diluted solution was used for ICP-OES measurement. The Li, Mn, Ti, measured are expressed as mol % of the total of these contents.

The amount of F in the positive electrode active material powder (as listed in Table 1) was measured with the F-ISE measurements. A ~0.5 g aliquot of the dissolved sample solution prepared above was measured and added to a plastic HDPE bottle. ~2 g of distilled water was added to the bottle. Finally, ~25 mL of a mixture of 15% aqueous sodium acetate: Tisab buffer (obtained from Cole-Parmer) in a 10:1 wt ratio was added, to adjust the final solution pH to be between 5 and 8, and to provide an ionic strength adjuster for fluoride. This final solution was used for the F-ISE measurement. Since the mass of every component of the final solution was measured, the amount of F in the original dissolved sample solution could be back calculated and the mol % of F in relation to Li, Mn, and Ti from ICP results could be obtained. The Li, Mn, Ti, F measured are expressed as mol % of the total of these contents.

Particle size distribution of the positive electrode active material powder, as provided in the sixth example, was measured by the SEM using ImageJ software according to the following steps. The SEM measurement is performed with a Thermo Fisher A preo C LoVac SEM instrument under a high vacuum environment of <1e-5 torr at 25 °C. The files (FIGS. 13a-13b) were each then loaded in ImageJ software with 800×−1500× times magnification. The SEM should have suitable contrast and brightness so that the edges of the particles are clearly observed. The scale is set according to the SEM magnification. Particles were manually sized across the longest axis. For ss-LMTO, 814 particles in the image of FIG. 13a were measured. For 5-minute mw-LMTO, 1500 particles in the image of FIG. 13b were measured. For each sample, the mean, median and standard deviation were calculated for the set particle sizes measured. The results of this statistical analysis showing the mean, median, and standard deviation is shown in FIGS. 14a-14b.

Data about the particle size distribution (PSD), as provided in the seventh example, such as particle size at set percentile (Dx(10), Dx(50), Dx(99)) and span were obtained by a laser PSD measurement method. The laser PSD was measured using a Malvern Mastersizer 3000 with Hydro 3000M V wet dispersion accessory. First, five drops of surfactant (Dolapix) were added to a beaker. Then, 0.5 grams of cathode was added using a spatula. The beaker was then filled with 40 mL volume of demineralized (DI) water. The solution was then sonicated for 30 seconds using a continuous pulse to improve dispersion. The solution was then dispersed using a 5 mL pipette in the Mastersizer Hydro Can until an obscuration of 7% was reached. Two measurements were taken to measure scattering of both a red and a blue light source, and an average of both measurements was used for reporting. Note that a narrow span (besides particle size homogeneity) is an indicator of a pronounced sphericity of a particle, the value of the span is used in the examples to measure sphericity.

### Advantages and Improvements

Cation-disordered rocksalt oxides/oxyfluorides (DRX) are a class of industrially relevant Li-ion cathode materials because they are made of Earth-abundant transition metals and enable the deployment of more sustainable, lower cost, and higher energy density secondary batteries. The cathode material of a battery is the component limiting the overall energy density of the cell, and typically the most expensive one. Currently, most Li-ion batteries use Co- and Ni-based cathode materials, which are plagued by complex supply chains, high price volatility, and high raw materials costs. Thus, the development of cathode materials depending on more sustainable elements, such as Mn and Fe is desirable. DRX materials can host a variety of different transition metals, and Mn-based DRX cathodes show good electrochemical performance and hold promise for the commercialization of low cost and high energy density Co/Ni-free batteries.

However, current methods to synthesize DRX cathodes involve time consuming and energy intensive steps, either sintering precursor powders at ≥800 °C for ≥10 hours, or mechanochemical ball milling of precursor powders at ~500 rpm for a long time (40 hours), typically in a sealed, inert argon (Ar) environment. The microwave synthesis process disclosed herein, on the other hand, is a rapid and energy efficient method to synthesize DRX compounds that can be performed in 5-20 minutes (faster than conventional methods by over two orders of magnitude). Moreover, the microwave synthesis method does not require an inert Ar atmosphere as is necessary for conventional solid-state and mechanochemical techniques. Thus, the microwave synthesis method should be highly appealing for battery cathode manufacturers as a significantly more scalable and cost-effective way to produce DRX compounds.

The inventive microwave synthesis method is also beneficial in that it can yield similar DRX compositions and atomic structures that are available from conventional solid-state synthesis, though with far less processing time and commensurate energy savings. For example, results show the amount of Li in LMTO (Li_{1.2}Mn_{0.4}Ti_{0.4}O₂) is the same when the microwave heating time is increased from 5, to 10 to 20 minutes, and upon solid-state synthesis after a 12 h calcination step. There are no significant differences in cation short-range order between mw- and ss-DRX, as evidenced from X-ray PDF analysis on LMTO and Li_{1.3}Mn_{0.4}Nb_{0.3}O₂₋ₓFₓ (LMNO/F) compounds. Long-term galvanostatic cycling shows very similar electrochemical performance between mw- and ss-DRX, for both LMTO and LMNO/F.

Larger amount of Li impurities at shorter microwave heating times indicating that Li excess is not necessary to synthesize phase-pure DRX via this new microwave synthesis method, providing potential that suitable DRX materials may be produced with a decreased emphasis on Li content. Experiments also show that F incorporation into the bulk DRX structure depends on the amount of Li excess used during the microwave synthesis and the nature of the d° transition metal. For instance, very little F is incorporated into LMTO prepared with 10% Li excess. Without Li excess, more significant fluorination is achieved in the MnTi DRX system, particularly at short reaction times. Compared to LMTO, greater amounts of F can be incorporated into the Li—Mn—Nb—O DRX structure prepared without excess Li, and no LiF is present in the as-synthesized microwave cathode sample. Thus, the microwave synthesis method of the present invention provides further potential for LMTO compositions to yield greater benefits from the incorporation of F in the presence of a relatively lesser Li content.

Slightly different Mn oxidation states are accessible in DRX compounds obtained via microwave synthesis and conventional, solid-state synthesis. From XANES, oxidation state of Mn in mw-LMTO and mw-LMNO/F DRX is slightly higher than ss-LMTO and ss-LMNO/F DRX, due to the more oxidizing environment used in the former method (ambient air versus Ar). Slightly different average redox potentials are also observed for DRX compounds obtained via microwave synthesis and conventional, solid-state synthesis. Differential capacity analysis shows that oxygen redox occurs at slightly higher voltages for mw-DRX compounds.

Surprisingly and unexpectedly, the microwave synthesis of the present invention may obtain powders of lithium metal oxide or oxyfluoride compound with particle size distributions advantageously useful for rechargeable batteries, with reduced number of post synthesis processing steps (e.g., without further milling, grinding, or other process steps that reduce the size of the particles, or with a reduced number of these steps).

### Method, Composition, and Electrode Embodiments

Example compositions, methods, and electrodes according to the present invention include, but are not limited to, the following.

1. A method of making a cathode active material useful as an electrode, comprising:
mixing ionic compound precursors together to form a precursor mixture,
microwaving the precursor mixture, comprising exposing the precursor mixture to microwave radiation with a power and duration so as to form a microwaved powder comprising an ionic compound comprising a rocksalt-type crystalline structure comprising a disordered arrangement of cations, wherein the rocksalt-type crystalline structure can be indexed to a cubic Fm-3m space group (#225); and
stopping the microwave radiation and quenching the microwaved powder (within 15 seconds of the stopping) to form the cathode active material retaining the rocksalt-type crystalline structure at room temperature

2. The method of example 1, further comprising grinding the cathode active material into a ground powder and further processing the ground powder into a form useful as the electrode comprising a Li ion battery electrode.

3. The method of any of examples 1 or 2, wherein the ionic compound comprises the cations comprising mobile alkali metal ions and at least one of transition metal ions or main element ions, and anions comprising at least one of an oxygen ion or a fluorine ion.

4. The method of example 3, wherein the mobile alkali metal ions comprise lithium or sodium.

5. The method of any of examples 3 or 4, wherein the ionic compound precursors do not include an excess of the mobile alkali metal ions to compensate for a loss of the corresponding element during exposure to microwave radiation.

6. The method of any of the examples 3 or 4, wherein the ionic compound precursors include an excess of the mobile alkali metal ions to compensate for a loss of the corresponding element during exposure to microwave radiation.

7. The method of any of the examples 1-6, wherein the rocksalt-type crystalline structure comprises a disordered rocksalt (DRX) oxide structure.

8. The method of any of examples 1-7, wherein the ionic compound is described:
at longer correlation lengths, by the cubic rocksalt-type crystalline structure corresponding to the disordered arrangement comprising a random distribution of the cations, and
at shorter correlation lengths, by a more ordered arrangement of the cations.

9. The method of any of the examples 1-7, further comprising selecting a specific quenching rate (°C/minute) of the quenching down to a temperature in the range of 77-323 K so as to prevent formation of any layered/ordered oxide impurities during the quenching.

10. The method of any of the examples 1-9, wherein the cathode active material comprises an oxyfluoride.

11. The method of any of the examples 1-10, wherein the ionic compound precursors are selected so as to form the cathode active material of the formula AₓM′_{y}M″_{2-x-y}O_{2-z}F_{z}, where 1.05≤x≤1.35, 0.1≤y≤0.9 and 0≤z≤0.7, A is a mobile alkali metal ion, M′ is a transition metal ion or main element ion, and M″ is a transition metal ion having higher valency than M′.

12. The method of example 11, wherein A is at least one of Lit or Nat, M′ is at least one of V, Cr, Mn, Fe, Co, Ni, Mg, Cu, Al and M″ is at least one of Ti⁴⁺, Zr⁴⁺, Nb⁵⁺, V⁵⁺, Mo⁶⁺.

13. The method of any of the examples 1-12, wherein the microwaving is performed in an inert atmosphere.

14. The method of any of the examples 1-12, wherein the microwaving is performed in an atmosphere consisting essentially of air at ambient (atmospheric) pressure.

15. The method of any of the examples 1-14, further comprising:
contacting the precursor mixture with a heat transfer medium having an absorption spectrum resonantly tuned to a frequency of the microwave radiation; and
wherein the microwaving comprises exposing the precursor mixture, in thermal contact with the heat transfer medium, to the microwave radiation, and:
   in a first stage, the heat transfer medium heats up by resonantly absorbing the microwave radiation and the heat transfer medium transfers at least some heat energy to the precursor mixture via conduction through thermal contact, so as to heat the precursor mixture above a critical temperature at which the precursor material becomes more susceptible to absorbing the microwave radiation; and
   in a second stage, when the precursor mixture is above the critical temperature, the microwave radiation heats up the precursor mixture to a higher reaction temperature (above 1500 °C, preferably above 1600 °C) initiating formation of the ionic compound comprising the disordered arrangement of the cations.

16. The method of example 15, wherein the heat transfer medium comprises activated carbon.

17. The method of any of the examples 15 or 16, wherein:
the microwaving comprises microwaving the precursor mixture placed in a crucible with the heat transfer medium; and
the quenching comprises:
   placing the microwaved powder in a quenching medium after removing the microwaved powder from the crucible; and
   drying the cathode active material after the quenching.

18. The method of any of the examples 15-17, wherein the quenching comprises immersing the microwaved powder in a non-reactive liquid, including water (e.g., distilled water), ethanol, or liquid nitrogen.

19 The method of example 2, wherein the further processing does not require ball milling or mechanochemical milling of the ionic compound precursors or precursor mixture.

20. The method of any of the examples 1-19, wherein a fluorinated compound is added to the mixture of ionic compound precursors and acts as a sintering agent to allow for faster diffusion of the cations and anions to form the rocksalt-type crystalline structure during the microwaving.

21. A composition of matter useful as cathode active material in an electrode, comprising a plurality of particles formed by quenching microwaved precursors (e.g., as illustrated in FIG. 3b or FIG. 13b).

22. The composition of matter of example 21, wherein each of the particles comprises a compound of the formula: AₓM′_{y}M″_{2-x-y}O_{2-z}F_{z}, wherein 1.05≤x≤1.35, 0.1≤y≤0.9 and 0≤z≤0.7, A is a mobile alkali metal ion (e.g., Li or Na), M′ is transition metal ion, and M″ is a transition metal ion having higher valency than M′.

23. The composition of matter of any of examples 21 or 22, comprising a powder comprising the particles comprising a lithium metal oxide or oxyfluoride compound for rechargeable batteries.

24 The composition of matter of any of examples 21-23, wherein the lithium metal oxide or oxyfluoride has the general formula: LiₓMn′_{y}Ti″_{2-x-y}O_{2-z}F_{z}, wherein 1.05≤x≤1.35, 0.1≤y≤0.9 and 0≤z≤0.7 is measured by ICP-OES, and the powder comprises particles having a median particle size of about 5 μm to about 6 μm with a span in the range of about 1.4 to about 1.8.

25. The composition of matter of any of the examples 21-24, formed by a process comprising:
mixing ionic compound precursors together to form a precursor mixture,
microwaving the precursor mixture, comprising exposing the precursor mixture to microwave radiation with a power and duration so as to form a microwaved powder comprising an ionic compound comprising a rocksalt-type crystalline structure comprising a disordered arrangement of cations, wherein the rocksalt-type crystalline structure can be indexed to a cubic Fm-3m space group (#225); and
stopping the microwave radiation and quenching the microwaved powder (within 15 seconds of the stopping) to form the cathode active material retaining the rocksalt-type crystalline structure at room temperature.

26 The composition of matter of any of the examples 22-25, wherein A is Lit or Nat, M′ is Mn and M″ is Ti and 80% of a number of the particles have a largest diameter in a range of 0.5-5 micrometers as synthesized by the quenching of the microwaved precursors and without further processing to reduce the size of the particles (e.g., grinding or milling).

27. The composition of matter of example 26, wherein the largest diameter of the particles is that as measured using a software tool applied to a scanning electron microscope image of the particles.

28. The composition of matter of any of examples 26 or 27, wherein the largest diameter has standard deviation of no more than 1.13 micrometers.

29. The composition of matter of any of examples 26-28, wherein 50% of the particles have the largest diameter less than 2.5 microns.

30. The composition of matter of any of the examples 22-29, wherein:
the transition metal ions have an oxidation state associated with an elemental composition of the compound formed by microwaving the precursors in air, and
a lithium content in the precursors prior to the microwaving does not contain excess lithium to account for lithium volatility during the microwaving, to reduce fluorine loss during the microwaving.

31. The composition of matter of any of the examples 22-30, wherein A is at least one of Li or Na, M′ is at least one of V, Cr, Mn, Fe, Co, Ni, Mg, Al, and M″ is at least one of Ti⁴⁺, Zr⁴⁺, Nb⁵⁺, Mo⁶⁺.

32. The composition of matter of any of the examples 22-31, further comprising fluorine substituting the oxygen.

33. The composition of matter of any of examples 22-32, wherein the fluorine content is greater than 0.1 or 0.2.

34. The method or composition of matter of any of the examples, wherein the microwaving is for a duration in a range of 2 minutes to 60 minutes.

A composition of matter useful as cathode active material in an electrode, comprising: a plurality of particles comprising a compound of the formula: AₓM′_{y}M″_{2-x-y}O_{2-z}F_{z}, measured by ICP, wherein: 1.05≤x≤1.35, 0.1≤y≤0.9 and 0≤z≤0.7, A is Lit or Nat, M′ is Mn and M″ is Ti; and
wherein the particles have a median particle size of about 5 μm to about 6 μm with a span in a range of about 1.4 to about 1.8; and/or
90% of a number of the particles have a largest diameter in a range of about 10.4 μm to about 12.5 μm and 50% of the number of the particles have the largest diameter less than about 5.3 μm to about 5.7 μm as synthesized without milling, polishing, grinding or any other further processing for reducing a size of the particles.

36. A powder of a lithium metal oxide or oxyfluoride compound for rechargeable batteries having a general formula LiₓMn′_{y}Ti″_{2-x-y}O_{2-z}F_{z}, wherein 1.05≤x≤1.35, 0.1<y≤0.9 and 0≤z≤0.7 as measured by ICP-OES, and wherein the powder has a median particle size of about 5 to about 6 μm with a span in the range of about 1.4 to about 1.8.

37. The powder of example 36 wherein said lithium metal oxide or oxyfluoride has a cation-disordered rocksalt (DRX) structure.

38. The powder of any of the examples 36 or 37 wherein the median particle size is obtained for an intermediate product without further processing that reduces the particle size.

39 The powder of any of the examples 36-38 manufactured using the method of any of the examples 1-20 or 34.

40. The powder of any of the examples 36-39, wherein the median particle size is that as measured by sizing the particles in a scanning electron microscope image along their longest dimension.

41. The powder of any of the examples 36-40, wherein the median particle size is that as measured for the particles obtained without further processing that reduces a size of the particles.

42. An electrochemical cell (e.g., lithium or sodium ion battery) comprising:
an anode;
an electrolyte; and
a cathode coupled via the electrolyte to the anode, wherein the cathode comprises the composition of matter of any of the examples 21-35 and wherein mobile alkali ion (Li or Na) intercalates or de-intercalates from the cathode during operation of the cell.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims, which in no way limit the scope of the disclosure.

### REFERENCES

The following references are incorporated herein in their entireties:
(1) Lee, J.; Kitchaev, D. A.; K won, D. H.; Lee, C. W.; Papp, J. K.; Liu, Y. S.; Lun, Z.; Clément, R. J.; Shi, T.; McCloskey, B. D.; Guo, J.; Balasubramanian, M.; Ceder, G. Reversible Mn2+/Mn4+ Double Redox in Lithium-Excess Cathode Materials. Nature 2018, 556 (7700), 185-190.
(2) Ji, H.; Urban, A.; Kitchaev, D. A.; K won, D.-H.; Artrith, N.; Ophus, C.; Huang, W.; Cai, Z.; Shi, T.; Kim, J. C.; Kim, H.; Ceder, G. Hidden Structural and Chemical Order Controls Lithium Transport in Cation-Disordered Oxides for Rechargeable Batteries. Nat. Commun. 2019, 10 (1), 592.
(3) Hyeseung Chung; Zachary Lebens-Higgins; Baharak Sayahpour; Carlos Mejia; Antonin Grenier; E. Kamm, G.; Yixuan Li; Ricky Huang; J. Piper, L. F.; W. Chapman, K.; Jean-Marie Doux; Shirley Meng, Y. Experimental Considerations to Study Li-Excess Disordered Rock Salt Cathode Materials. J. Mater. Chem. A 2021, 9 (3), 1720-1732.
(4) Baur, C.; Källquist, I.; Chable, J.; Chang, J. H.; Johnsen, R. E.; Ruiz-Zepeda, F.; A teba M ba, J. M.; Naylor, A. J.; Garcia-Lastra, J. M.; Vegge, T.; Klein, F.; Schür, A. R.; Norby, P.; Edström, K.; Hahlin, M.; Fichtner, M. Improved Cycling Stability in High-Capacity Li-Rich Vanadium Containing Disordered Rock Salt Oxyfluoride Cathodes. J. Mater. Chem. A 2019, 7 (37), 21244-21253.
(5) Crafton, M. J.; Y ue, Y.; Huang, T.-Y.; Tong, W.; McCloskey, B. D.; Crafton, M. J.; Huang, T.; McCloskey, B. D.; Y ue, Y.; Tong, W. Anion Reactivity in Cation-Disordered Rocksalt Cathode Materials: The Influence of Fluorine Substitution. Adv. Energy Mater. 2020, 10 (35), 2001500.
(6) Ji, H.; Urban, A.; Kitchaev, D. A.; Kwon, D.-H.; Artrith, N.; Ophus, C.; Huang, W.; Cai, Z.; Shi, T.; Kim, J. C.; Kim, H.; Ceder, G. Hidden structural and chemical order controls lithium transport in cation-disordered oxides for rechargeable batteries. Nature Communications 2019, 10, 592.
(7) Clément, R. J.; Lun, Z.; Ceder, G. Cation-disordered rocksalt transition metal oxides and oxyfluorides for high energy lithium-ion cathodes. Energy Environ. Sci. 2020, 13, 345.
(8) Wu, V. C., Evans, H. A., Giovine, R., Preefer, M. B., Ong, J., Y oshida, E., Cabelguen, P.-E., Clément, R. J., Rapid and Energy-Efficient Synthesis of Disordered Rocksalt Cathodes. Adv. Energy Mater. 2023, 13, 2203860.

1. A method of making an active material useful as an electrode, comprising:
mixing ionic compound precursors together to form a precursor mixture,
exposing the precursor mixture to microwave radiation with a power and duration sufficient to form a microwaved powder comprising an ionic compound having a rocksalt-type crystalline structure with a disordered arrangement of cations, the rocksalt-type crystalline structure being in a cubic Fm-3m space group; and
quenching the microwaved powder to form the active material retaining the rocksalt-type crystalline structure at room temperature.

2. The method of claim 1, further comprising grinding the active material into a ground powder and processing the ground powder into a form useful as an electrode comprising a Li ion battery electrode.

3. The method of claim 1, wherein the ionic compound comprises cations comprising mobile alkali metal ions and at least one of transition metal ions or main element ions, and anions comprising at least one of an oxygen ion or a fluorine ion.

4. The method of claim 3, wherein the mobile alkali metal ions comprise lithium or sodium.

5. The method of claim 3, wherein the ionic compound precursors do not include an excess of the mobile alkali metal ions to compensate for a loss of the corresponding element during exposure to microwave radiation.

6. The method of claim 3, wherein the ionic compound precursors include an excess of the mobile alkali metal ions to compensate for a loss of the corresponding element during exposure to microwave radiation.

7. The method of claim 1, wherein the rocksalt-type crystalline structure comprises a disordered rocksalt (DRX) oxide structure.

8. The method of claim 1, wherein the ionic compound is described:
at longer correlation lengths, by the cubic rocksalt-type crystalline structure corresponding to the disordered arrangement comprising a random distribution of the cations, and
at shorter correlation lengths, by a more ordered arrangement of the cations.

9. The method of claim 1, further comprising selecting a specific quenching rate (°C/minute) of the quenching down to a temperature in the range of 77-323 K so as to prevent formation of any layered/ordered oxide impurities during the quenching.

10. The method of claim 1, wherein the cathode active material comprises an oxyfluoride.

11. The method of claim 1, wherein the ionic compound precursors are selected so as to form the cathode active material of the formula AₓM′_{y}M″_{2-x-y}O_{2-z}F_{z}, where 1.05≤x≤1.35, 0.1≤y≤0.9 and 0≤z≤0.7, A is a mobile alkali metal ion, M′ is a transition metal ion or main element ion, and M″ is a transition metal ion having higher valency than M′.

12. The method of claim 11, wherein A is at least one of Li⁺ or Na⁺, M′ is at least one of V, Cr, Mn, Fe, Co, Ni, Mg, Al and M″ is at least one of Ti⁴⁺, Zr⁴⁺, Nb⁵⁺, Mo⁶⁺.

13. The method of claim 1, wherein the microwaving is performed in an inert atmosphere.

14. The method of claim 1, wherein the microwaving is performed in an atmosphere consisting essentially of air at ambient (atmospheric) pressure.

15. The method of claim 1, further comprising:
contacting the precursor mixture with a heat transfer medium having an absorption spectrum resonantly tuned to a frequency of the microwave radiation; and
wherein the microwaving comprises exposing the precursor mixture, in thermal contact with the heat transfer medium, to the microwave radiation, and:
in a first stage, the heat transfer medium heats up by resonantly absorbing the microwave radiation and the heat transfer medium transfers at least some heat energy to the precursor mixture via conduction through thermal contact, so as to heat the precursor mixture above a critical temperature at which the precursor material becomes more susceptible to absorbing the microwave radiation; and
in a second stage, when the precursor mixture is above the critical temperature, the microwave radiation heats up the precursor to a higher reaction temperature initiating formation of the ionic compound comprising the disordered arrangement of the cations.

16. The method of claim 15, wherein the heat transfer medium comprises activated carbon.

17. The method of claim 15, wherein:
the microwaving comprises microwaving the precursor mixture placed in a crucible with the heat transfer medium; and
the quenching comprises placing the microwaved powder in a quenching medium after removing the microwaved powder from the crucible.

18. The method of claim 15, wherein the quenching comprises immersing the microwaved powder in a non-reactive liquid, including water, ethanol, or liquid nitrogen.

19. The method of claim 2, wherein the further processing does not require ball milling or mechanochemical milling.

20. The method of claim 1, wherein a fluorinated compound is added to the mixture of ionic compound precursors and acts as a sintering agent to allow for faster diffusion of the cations and anions to form the rocksalt-type crystalline structure during the microwaving.

21. A powder of a lithium metal oxide or oxyfluoride compound for rechargeable batteries comprising a general formula LiₓMn′_{y}Ti″_{2-x-y}O_{2-z}F_{z}, wherein:
1.05≤x≤1.35, 0.1≤y≤0.9 and 0≤z≤0.7 as measured by Inductively Coupled Plasma Optical Emission Spectroscopy (ICP-OES), and
the powder comprises particles having a median particle size of about 5 μm to about 6 μm with a span in the range of about 1.4 to about 1.8.

22. The powder of claim 21 wherein said lithium metal oxide or oxyfluoride has a cation-disordered rocksalt (DRX) structure.

23. The powder of claim 21, wherein the median particle size is that as measured by sizing the particles in a scanning electron microscope image along their longest dimension.

24. The powder of claim 21, wherein the median particle size is that as measured for the particles obtained without further processing that reduces a size of the particles.

25. The powder of claim 21 as synthesized by a method comprising
mixing ionic compound precursors together to form a precursor mixture,
exposing the precursor mixture to microwave radiation with a power and duration sufficient to form a microwaved powder comprising an ionic compound having a rocksalt-type crystalline structure with a disordered arrangement of cations, the rocksalt-type crystalline structure being in a cubic Fm-3m space group; and
quenching the microwaved powder to form the active material retaining the rocksalt-type crystalline structure at room temperature.

26. An electrochemical cell comprising:
an anode;
an electrolyte; and
a cathode coupled via the electrolyte to the anode, wherein the cathode comprises the powder of claim 21 and wherein the Li intercalates or de-intercalates from the cathode during operation of the cell.
